(19) United States
(12) Patent Application Publication
(10) Pub. No.: US 2026/0287138 A1
(43) Pub. Date: Sep. 24, 2026

(54) VEHICLE LAMP

(71) Applicant: KOITO MANUFACTURING CO., LTD., Tokyo (JP)

(72) Inventors: Koki MATSUNAGA, Shizuoka-shi, Shizuoka (JP); Yuta UGAJIN, Shizuoka-shi, Shizuoka (JP)

(73) Assignee: KOITO MANUFACTURING CO., LTD., Tokyo (JP)

(21) Appl. No.: 19/164,397

(22) PCT Filed: Mar. 18, 2024
(86) PCT No.: PCT/JP2024/010419

§ 371 Date: Sep. 11, 2025

(30) Foreign Application Priority Data
Mar. 22, 2023 (JP) 2023-045241

(51) Int. Cl. F21S 41/43; B60Q 1/14; F21S 41/148; F21S 41/25; F21S 41/32; F21W 102/14

(52) U.S. Cl. CPC F21S 41/43; B60Q 1/1438; F21S 41/25; F21S 41/321; F21S 41/148; F21W 2102/14

(57) ABSTRACT

Please delete the present Abstract of the Disclosure.

Please add the following new Abstract of the Disclosure:

A vehicle lamp configured to form a low beam light distribution pattern. The vehicle lamp includes: a projection lens; a light source disposed on a lamp rear side with respect to a rear focal point of the projection lens; and a shade disposed between the light source and the projection lens, and configured to block a part of light emitted from the light source to form a cutoff line of the low beam light distribution pattern. The shade is configured to form, as the cutoff line, a stepped cutoff line in which a lower cutoff line and an upper cutoff line are connected via an inclined portion. A shape of the shade is set such that an inclination angle of the inclined portion is smaller in a lower region than in an upper region of the inclined portion.

### TITLE OF INVENTION: VEHICLE LAMP

### Technical Field

The present invention relates to a vehicle lamp configured to form a low beam light distribution pattern.

### BACKGROUND ART

In the related art, a known vehicle lamp for forming a low beam light distribution pattern includes: a projection lens; a light source disposed on a lamp rear side than a rear focal point of the projection lens; and a shade disposed between the projection lens and the light source to block a part of light emitted from the light source in order to form a cutoff line of the low beam light distribution pattern.

Patent Literature 1 describes such a vehicle lamp configured to form a stepped cutoff line in which a lower cutoff line and an upper cutoff line are connected via an inclined portion as the cutoff line.

### CITATION LIST

### Patent Literature

Patent Literature 1: JP2017-183056A

### SUMMARY OF INVENTION

### Technical Problem

If an inclination angle of the inclined portion is set to a large value in a stepped cutoff line formed by irradiation light from such a vehicle lamp, it is possible to prevent glare to an oncoming vehicle driver or the like, but the visibility of a long-distance region of a vehicle front travel path is reduced.

On the other hand, when the inclination angle of the inclined portion is set to a small value, it is possible to improve the visibility of a long-distance region of the vehicle front travel path, but it becomes difficult to prevent glare to an oncoming vehicle driver or the like.

The present invention has been made in view of such circumstances, and an object of the present invention is to provide a vehicle lamp configured to form a low beam light distribution pattern that can prevent glare to an oncoming vehicle driver or the like and improve long-distance visibility of a vehicle front travel path.

### Solution to Problem

The present invention aims to achieve the above object by devising the shape of the shade.

That is, a vehicle lamp according to the present invention is a vehicle lamp configured to form a low beam light distribution pattern, the vehicle lamp including:
a projection lens;
a light source disposed on a lamp rear side with respect to a rear focal point of the projection lens; and
a shade disposed between the light source and the projection lens, and configured to block a part of light emitted from the light source to form a cutoff line of the low beam light distribution pattern, in which
the shade is configured to form, as the cutoff line, a stepped cutoff line in which a lower cutoff line and an upper cutoff line are connected via an inclined portion, and
a shape of the shade is set such that an inclination angle of the inclined portion is smaller in a lower region than in an upper region of the inclined portion.

The above “shade” is not particularly limited in a specific configuration as long as the shade is configured to form a stepped cutoff line as a cutoff line of a low beam light distribution pattern by blocking a part of reflected light from a reflector.

The above “shape of the shade” is not particularly limited in a specific shape as long as the shape is set such that the inclination angle of the inclined portion of the stepped cutoff line is smaller in the lower region than in the upper region.

### Advantageous Effects of Invention

The vehicle lamp according to the present invention is configured to block a part of light emitted from the light source by the shade disposed between the light source and the projection lens, thereby forming the stepped cutoff line in which the lower cutoff line and the upper cutoff line are connected via the inclined portion as the cutoff line of the low beam light distribution pattern. However, the shape of the shade is set such that the inclination angle of the inclined portion is smaller in the lower region than in the upper region, so that the following operational effects can be obtained.

That is, since the inclined portion of the stepped cutoff line has a large inclination angle in the upper region, it is possible to prevent glare to an oncoming vehicle driver, a preceding vehicle driver or the like, and on the other hand, since the inclination angle in the lower region is small, it is possible to improve the visibility of a long-distance region of the vehicle front travel path.

As described above, according to the present invention, in a vehicle lamp configured to form a low beam light distribution pattern, glare to an oncoming vehicle driver or the like can be prevented and long-distance visibility of a vehicle front travel path can be improved.

In the above configuration, when the shape of the shade is set such that the inclination angle of the inclined portion gradually decreases from an upper end edge toward a lower end edge, it is possible to easily achieve both prevention of glare to an oncoming vehicle driver or the like and improvement of long-distance visibility of a vehicle front travel path.

At this time, when the shape of the shade is set such that the lower end edge of the inclined portion is smoothly connected to the lower cutoff line, it is possible to maximize the improvement in the long-distance visibility of the vehicle front travel path.

In the above configuration, when a reflector disposed to cover the light source from above and configured to reflect the light emitted from the light source toward the projection lens is further provided, and a part of light emitted from the light source and reflected by the reflector is blocked by the shade, the low beam light distribution pattern can be easily formed in a desired pattern shape.

In a case where such a configuration is adopted, the brightness of the low beam light distribution pattern can be increased by adopting a configuration in which the shade includes an upward reflection surface that reflects reflected light from the reflector upward toward the projection lens, and the stepped cutoff line is formed at a front end edge of the upward reflection surface.

At this time, when the upward reflection surface in a lamp rear region of a portion that forms the inclined portion of the stepped cutoff line in the shade is formed such that the inclination angle is smaller in the lower region than in the upper region, the reflected light from the lamp rear region can be diffused in the left-right direction, and thus the light distribution unevenness can be make less likely to occur in the low beam light distribution pattern.

### BRIEF DESCRIPTION OF DRAWINGS

FIG. 1 is a front view showing a vehicle lamp according to an embodiment of the present invention.

FIG. 2 is a plan view showing a lamp unit of the vehicle lamp.

FIG. 3 is a cross-sectional view taken along a line III-III in FIG. 2.

FIG. 4 is a perspective view showing a main part of the lamp unit.

FIG. 5 is a detailed view of a part V in FIG. 1.

FIG. 6 FIG. 6A is a diagram showing a low beam light distribution pattern formed by irradiation light from the vehicle lamp, and FIG. 6B is a detailed view of a part b in FIG. 6A.

FIG. 7 is a view similar to FIG. 5, showing a first modification of the embodiment.

FIG. 8 FIGS. 8A and 8B are views similar to FIGS. 6A and 6B, showing an operation of the first modification.

FIG. 9 is a view similar to FIG. 1, showing a second modification of the embodiment.

FIG. 10 FIGS. 10A and 10B are views similar to FIGS. 6A and 6B, showing an operation of the second modification.

### DESCRIPTION OF EMBODIMENTS

Hereinafter, an embodiment of the invention will be described with reference to the drawings.

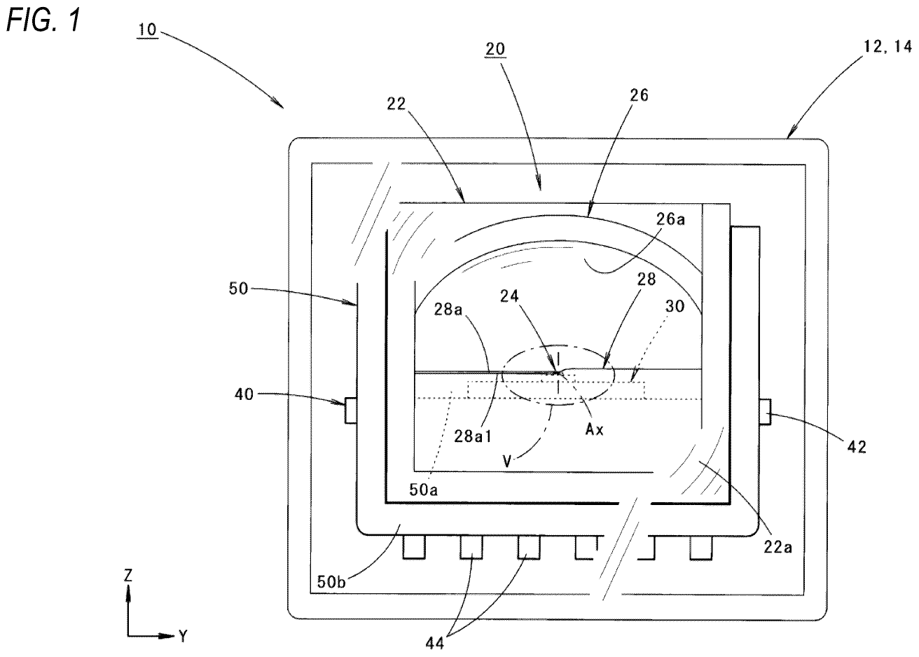

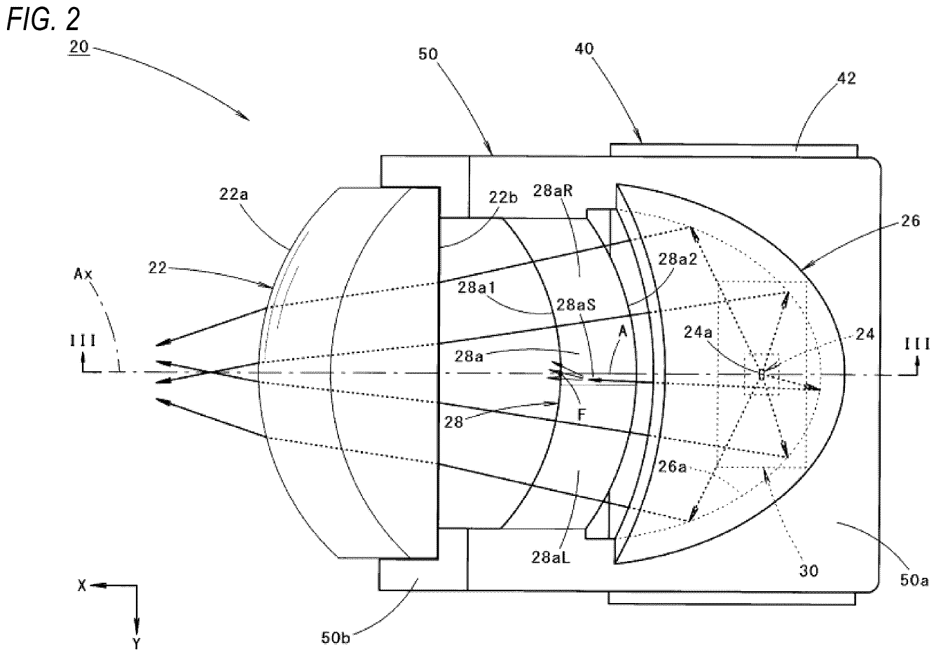

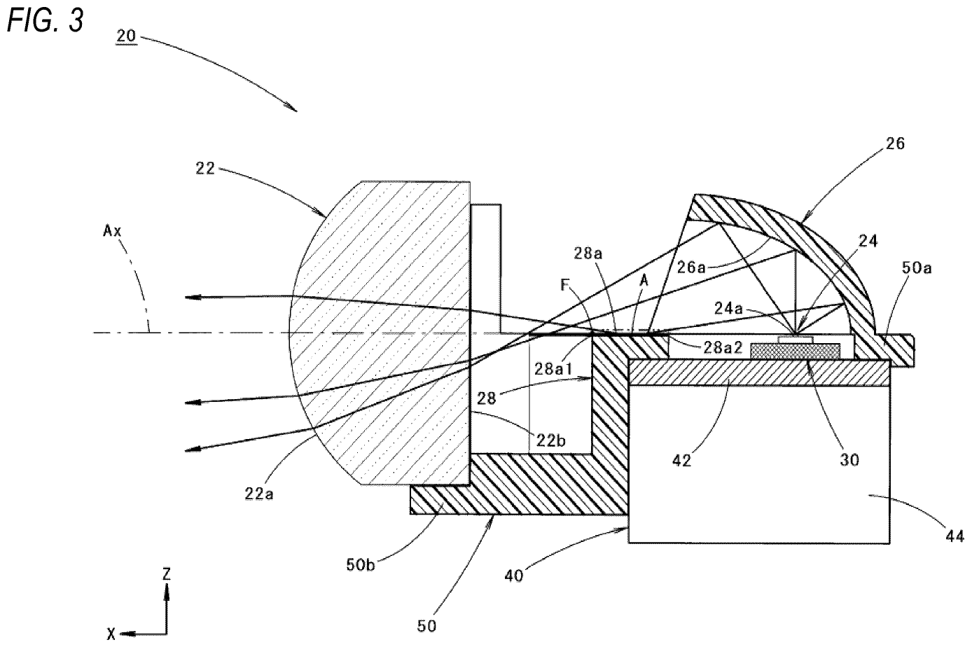

FIG. 1 is a front view showing a vehicle lamp 10 according to an embodiment of the present invention. FIG. 2 is a plan view showing a lamp unit 20 of the vehicle lamp 10, and FIG. 3 is a cross-sectional view taken along a line III-III in FIG. 2.

In FIGS. 1 to 3, a direction indicated by X is “the front of the lamp”, a direction indicated by Y is a “left direction” (a “right direction” in a front view of the lamp) orthogonal to “the front of the lamp”, and a direction indicated by Z is an “upward direction”. The same applies to figures other than FIGS. 1 to 3.

As illustrated in FIG. 1 to 3, the vehicle lamp 10 according to the embodiment is a headlamp disposed at a front end portion of a vehicle, and has a configuration in which a lamp unit 20 is accommodated in a lamp chamber formed by a lamp body 12 and a plain translucent cover 14 attached to a front end opening of the lamp body 12.

The lamp unit 20 is a projector type lamp unit and is configured to form a low beam light distribution pattern.

Specifically, the lamp unit 20 includes: a projection lens 22 having an optical axis Ax extending in a front-rear direction of the lamp; a light source 24 disposed on lamp rear side than a rear focal point (more precisely, a rear focal point in a vertical cross section) F of the projection lens 22; a reflector 26 disposed to cover the light source 24 from above and configured to reflect light emitted from the light source 24 toward the projection lens 22; and a shade 28 disposed between the reflector 26 and the projection lens 22 and configured to block a part of reflected light from the reflector 26.

The projection lens 22 is a plano-convex aspherical lens in which a front surface 22a is a convex curved surface and a rear surface 22b is a flat surface, and projects a light source image formed on a rear focal plane, which is a focal plane including the rear focal point F of the projection lens 22, as an inverted image onto a virtual vertical screen in front of the lamp. The projection lens 22 has a horizontally elongated rectangular shape when viewed from the front of the lamp.

The light source 24 is a light emitting element (specifically, a white light emitting diode), and has a light emitting surface 24a having a horizontally elongated rectangular shape. The light source 24 is supported by a substrate 30 with the light emitting surface 24a facing upward along the optical axis Ax.

The reflector 26 is configured to cause light emitted from the light source 24 to enter the projection lens 22 as convergent light.

Specifically, a reflection surface 26a of the reflector 26 is formed as a curved surface having a substantially ellipsoidal shape with a light emission center of the light source 24 as a first focal point, and the eccentricity thereof is set to gradually increase from a vertical cross section toward a horizontal cross section. Accordingly, the reflector 26 converges the light emitted from the light source 24 to a point located on a lamp front side than the rear focal point F in the vertical cross section, and displaces a convergence position further toward the lamp front side in the horizontal cross section.

The shade 28 has an upward reflection surface 28a that reflects a part of the reflected light from the reflector 26 upward toward the projection lens 22.

The upward reflection surface 28a is formed such that a front end edge 28a1 thereof extends in a curved manner from the rear focal point F of the projection lens 22 toward the lamp front side on both the left and right sides, and a rear end edge 28a2 thereof also extends in a curved manner toward the lamp front side on both left and right sides. In addition, the upward reflection surface 28a is formed such that the rear end edge 28a2 thereof is positioned on the lamp front side with respect to a front end edge of the reflection surface 26a in the reflector 26, so that the shade 28 and the reflector 26 do not overlap each other in a plan view.

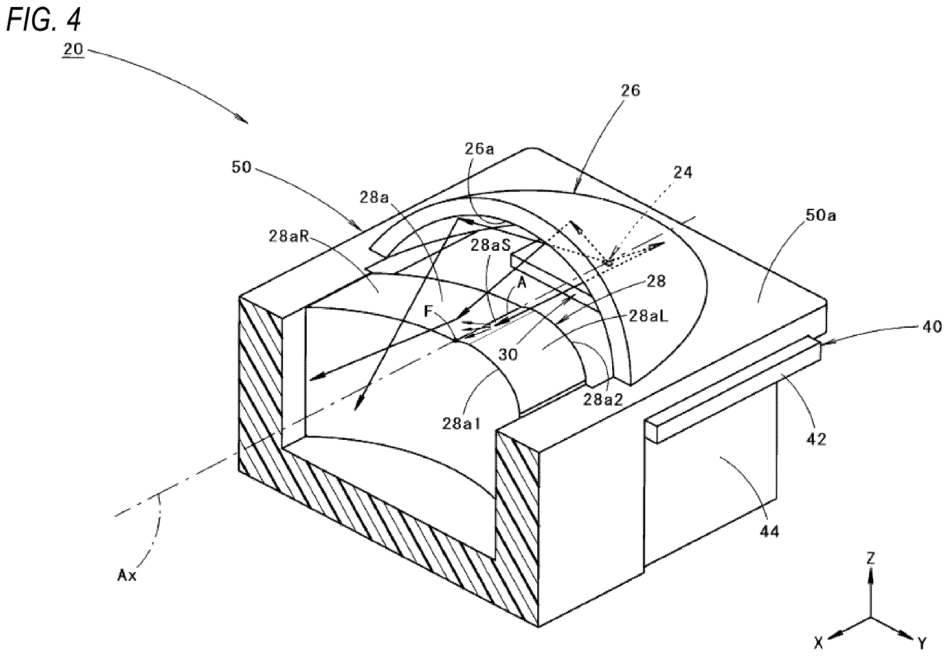

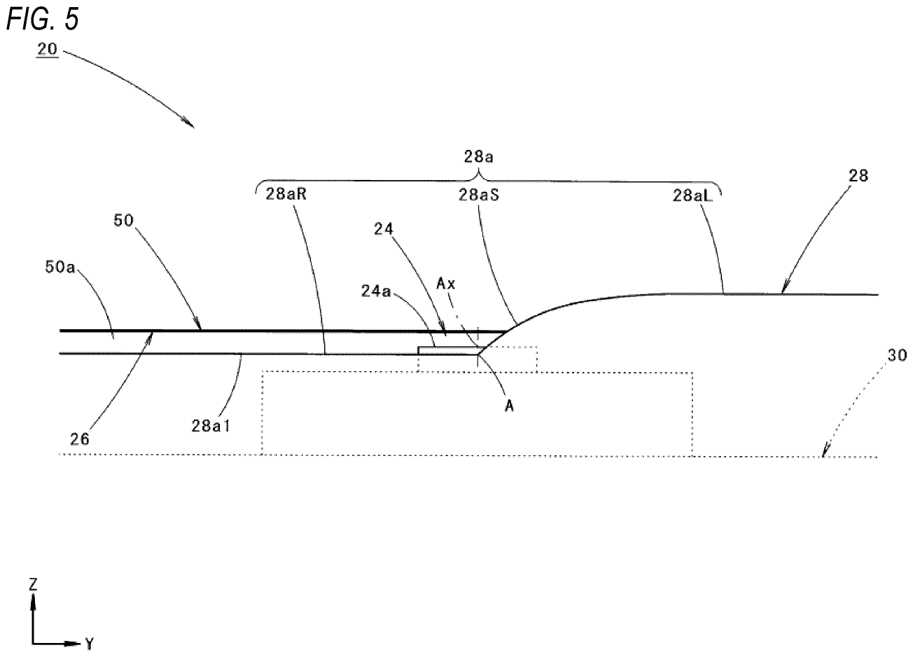

FIG. 4 is a perspective view showing a main part of the lamp unit 20. FIG. 5 is a detailed view of a part V in FIG. 1.

As illustrated in FIGS. 4 and 5, the upward reflection surface 28a of the shade 28 is formed such that a right side region 28aR, which is located on the right side (the left side in the front view of the lamp) of the optical axis Ax, extends along a horizontal plane slightly below the optical axis Ax, and a left side region 28aL, which is located on the left side of the optical axis Ax, extends along a horizontal plane above the optical axis Ax via a slope region 28aS.

That is, a connection position A between the slope region 28aS and the right side region 28aR is located below and in the vicinity of the optical axis Ax. Further, an amount of upward displacement from the optical axis Ax of the horizontal plane constituting the left side region 28aL is set to a value larger than an amount of downward displacement from the optical axis Ax of the horizontal plane constituting the right side region 28aR.

The slope region 28aS is formed so as to have an upwardly convex curved vertical cross-sectional shape extending in the front-rear direction of the lamp. The convex curved surface constituting this slope region 28aS extends diagonally upward at an inclination angle of approximately 45° from the connection position A with the right side region 28aR, and then the upward inclination angle gradually decreases, and is formed so as to be smoothly connected to a general region of the left side region 28aL.

The lamp unit 20 is supported by a metal heat sink 40 via the substrate 30, and the heat sink 40 is supported by a resin holder member 50.

The holder member 50 has a horizontal flange portion 50a that extends along a horizontal plane so as to surround an outer peripheral edge portion of the reflector 26.

The heat sink 40 includes a main body portion 42 extending in a left-right direction along a horizontal plane, and a plurality of heat radiation fins 44 formed to extend downward from a lower surface of the main body portion 42. The plurality of heat radiation fins 44 are disposed at intervals in the left-right direction. The heat sink 40 is attached to the holder member 50 in a state where the main body portion 42 is in contact with the horizontal flange portion 50a of the holder member 50 from below.

The reflector 26 and the shade 28 are formed integrally with the holder member 50, and the projection lens 22 is supported by the holder member 50.

A frame portion 50b is formed at a front end portion of the holder member 50 and extends along a vertical plane orthogonal to the front-rear direction of the lamp. The frame portion 50b is formed in a horizontally long U-shape in the front view of the lamp, and has an L-shaped cross-sectional shape. The projection lens 22 is supported by the holder member 50 in a state where a peripheral edge portion of a rear surface of the projection lens 22 is in contact with the frame portion 50b of the holder member 50 from the lamp front side.

In the lamp unit 20, the reflector 26, the shade 28, and the holder member 50 do not have overlapping portions in the plan view, and thus when these elements are molded into a single injection molded product, a structure of a mold used for the injection molded product is simple.

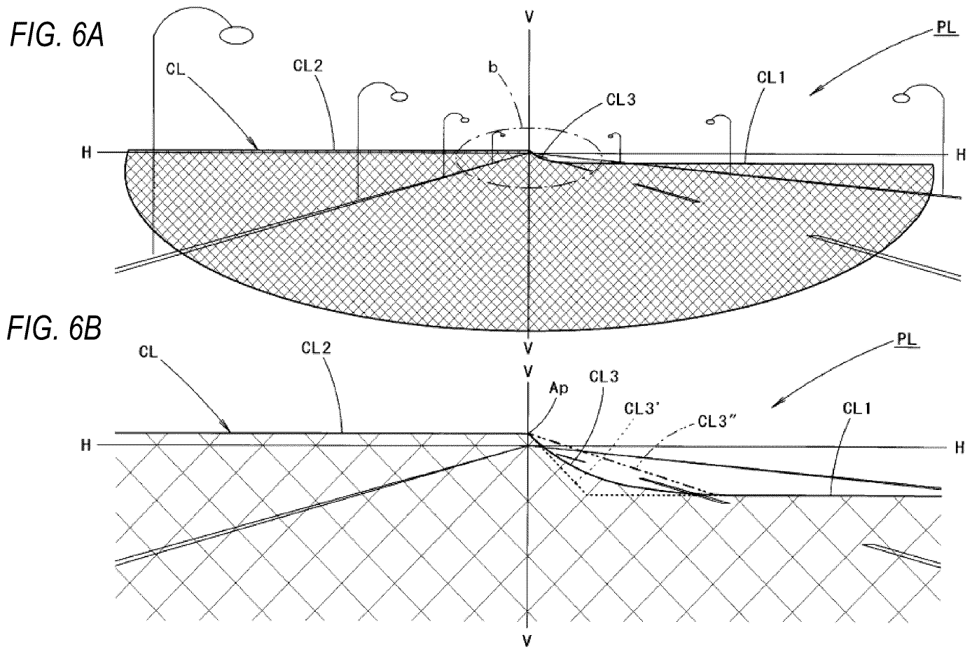

FIG. 6A is a diagram showing a low beam light distribution pattern PL formed by the irradiation light from the vehicle lamp 10 in a see-through manner.

As shown in FIG. 6A, the low beam light distribution pattern PL is a low beam light distribution pattern for left light distribution, and a cutoff line thereof is formed as a stepped cutoff line CL in which a lower cutoff line CL1 and an upper cutoff line CL2 are connected via an inclined portion CL3. The stepped cutoff line CL is formed as an inverted projection image of the front end edge 28a1 of the upward reflection surface 28a of the shade 28.

The lower cutoff line CL1 is formed to extend in the horizontal direction on the right side (that is, on the oncoming traffic lane side) of a line V-V that passes through H-V, which is a vanishing point in a front direction of the lamp, in the vertical direction. The lower cutoff line CL 1 is located about 0.5° to 0.6° below a line H-H that passes through the H-V in the horizontal direction.

The upper cutoff line CL2 is formed to extend in the horizontal direction on the left side (that is, the own lane side) of the line V-V. The upper cutoff line CL2 is located above the line H-H, and an amount of upward displacement from the line H-H is set to a value of about 0.1° to 0.3°.

The inclined portion CL3 is formed to be located on the right side of the line V-V, and at a left end portion of the lower cutoff line CL1.

FIG. 6B is a detailed view of a part b in FIG. 6A, and is a view showing a main part of the low beam light distribution pattern PL.

As illustrated in FIG. 6B, the inclined portion CL3 of the stepped cutoff line CL has a smaller inclination angle in the lower region than in the upper region.

Specifically, the inclination angle of the inclined portion CL3 gradually decreases from the upper end edge toward the lower end edge, the inclination angle at a connection position Ap with the upper cutoff line CL 2 is approximately 45° and the inclination angle at the lower end edge is 0°. Therefore, the inclined portion CL3 is smoothly connected to the lower cutoff line CL1.

As described above, for the low beam light distribution pattern PL, the inclination angle of the inclined portion CL3 of the stepped cutoff line CL is set to be smaller in the lower region than in the upper region, so that the long-distance visibility of the vehicle front travel path is improved while preventing glare to an oncoming vehicle driver or the like.

Next, operations and effects of the present embodiment will be described.

The vehicle lamp 10 according to the present embodiment is configured to block a part of light emitted from the light source 24 by the shade 28 disposed between the light source 24 and the projection lens 22, thereby forming the stepped cutoff line CL in which the lower cutoff line CL1 and the upper cutoff line CL2 are connected via the inclined portion CL3 as the cutoff line of the low beam light distribution pattern PL, and the shape of the shade 28 is set such that the inclination angle of the inclined portion CL3 is smaller in the lower region than in the upper region, so that the following operational effects can be obtained.

That is, instead of the inclined portion CL3 of the stepped cutoff line CL, if the inclination angle is made steep as a whole as in an inclined portion CL3′ indicated by a broken line in FIG. 6B, the long-distance visibility of the vehicle front travel path is likely to decrease, and on the other hand, if the inclination angle is made gentle as a whole as in an inclined portion CL3″ indicated by a two-dot chain line in FIG. 6B, glare to an oncoming vehicle driver, a preceding vehicle driver, or the like is likely to occur.

In this regard, since the inclined portion CL3 of the stepped cutoff line CL formed in the present embodiment has a large inclination angle in the upper region, it is possible to prevent glare to an oncoming vehicle driver, a preceding vehicle driver or the like, and on the other hand, since the inclination angle in the lower region is small, it is possible to improve the visibility of a long-distance region of the vehicle front travel path.

As described above, according to the present embodiment, in the vehicle lamp 10 configured to form the low beam light distribution pattern PL, glare to an oncoming vehicle driver or the like can be prevented and long-distance visibility of a vehicle front travel path can be improved.

At this time, in the present embodiment, since the shape of the shade 28 is set such that the inclination angle of the inclined portion CL3 gradually decreases from the upper end edge toward the lower end edge, it is possible to easily achieve both prevention of glare to an oncoming vehicle driver or the like and improvement of long-distance visibility of a vehicle front travel path.

Further, in the present embodiment, since the shape of the shade 28 is set such that the lower end edge of the inclined portion CL3 is smoothly connected to the lower cutoff line CL1, it is possible to maximize the improvement in the long-distance visibility of the vehicle front travel path.

Further, the vehicle lamp 10 according to the present embodiment includes the reflector 26 disposed to cover the light source 24 from above and configured to reflect the light emitted from the light source 24 toward the projection lens, and is configured such that a part of the light emitted from the light source 24 and reflected by the reflector 26 is blocked by the shade 28. Therefore, it is possible to easily form the low beam light distribution pattern PL in a desired pattern shape.

In this case, the shade 28 includes the upward reflection surface 28a that reflects the reflected light from the reflector 26 upward toward the projection lens, and is configured to form the stepped cutoff line CL at the front end edge 28a1of the upward reflection surface 28a. Therefore, the brightness of the low beam light distribution pattern PL can be increased.

Further, as illustrated in FIGS. 2 and 4, the slope region 28aS in the upward reflection surface 28a of the shade 28 is formed so as to have an upwardly convex curved vertical cross-sectional shape extending in the front-rear direction of the lamp, so that it is possible to diffuse the reflected light from the slope region 28aS in the left-right direction, and thus, it is possible to effectively prevent uneven light distribution from occurring in the low beam light distribution pattern PL.

In the above embodiment, as the stepped cutoff line CL of the low beam light distribution pattern PL, the inclination angle of the inclined portion CL3 has been described as being formed at approximately 45° at the upper end edge and 0° at the lower end edge, but the inclination angle at the upper end edge may be set to a value other than 45°, and the inclination angle at the lower end edge may be set to a value other than 0°.

In the above-described embodiment, the shade 28 of the lamp unit 20 has been described as having the connection position A between the slope region 28aS and the right side region 28aR of the upward reflection surface 28a located below and in the vicinity of the optical axis Ax. However, by adopting a configuration in which the connection position A is set at a position displaced in the upper-lower direction or the left-right direction from this position, it is also possible to displace the connection position Ap between the inclined portion CL3 and the upper cutoff line CL2 in the stepped cutoff line CL in the upper-lower direction or the left-right direction from a position slightly above the H-V as the low beam light distribution pattern PL.

In the above embodiment, the shade 28 of the lamp unit 20 has been described as having the front end edge 28a1 and the rear end edge 28a2 of the upward reflection surface 28a formed so as to extend in a curved manner toward the lamp front side on both the left and right sides, but it is also possible to adopt a configuration in which the front end edge 28a1 and the rear end edge 28a2 are formed so as to extend in a straight line on both the left and right sides.

Next, modifications of the above embodiment will be described.

First, a first modification of the above embodiment will be described.

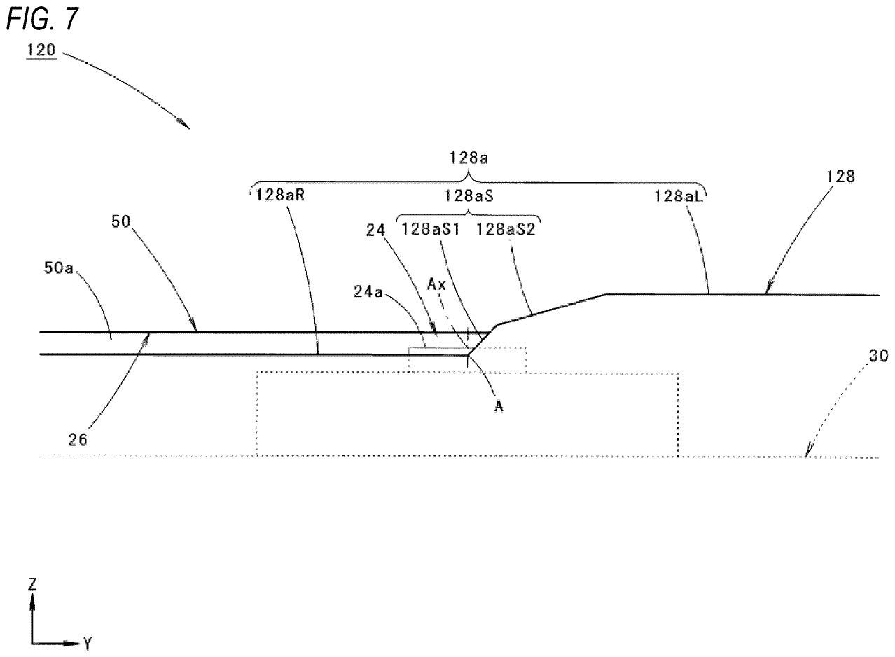

FIG. 7 is a view similar to FIG. 5, showing a main part of a lamp unit 120 in a vehicle lamp according to the modification.

As illustrated in FIG. 7, although a basic configuration according to the present modification is the same as that of the above embodiment, a configuration of a shade 128 is partially different from that of the above embodiment.

That is, the shade 128 according to the present modification is different from the case of the above-described embodiment in that a slope region 128aS of the upward reflection surface 128a is formed to have an upwardly facing convex polygonal vertical cross section extending in the front-rear direction of the lamp. In the shade 128, the connection position A between the slope region 128aS and the right side region 128aR is also set below and in the vicinity of the optical axis Ax.

In the shade 128 according to the present modification, a surface of the convex polygon constituting the slope region 128aS extends obliquely upward at an inclination angle of approximately 45° from the connection position A with the right side region 128aR in a lower half 128aS1, and is connected to a left side region 128aL in a broken line in a state of being formed to extend obliquely upward at an inclination angle of approximately 15° in an upper half 128aS2.

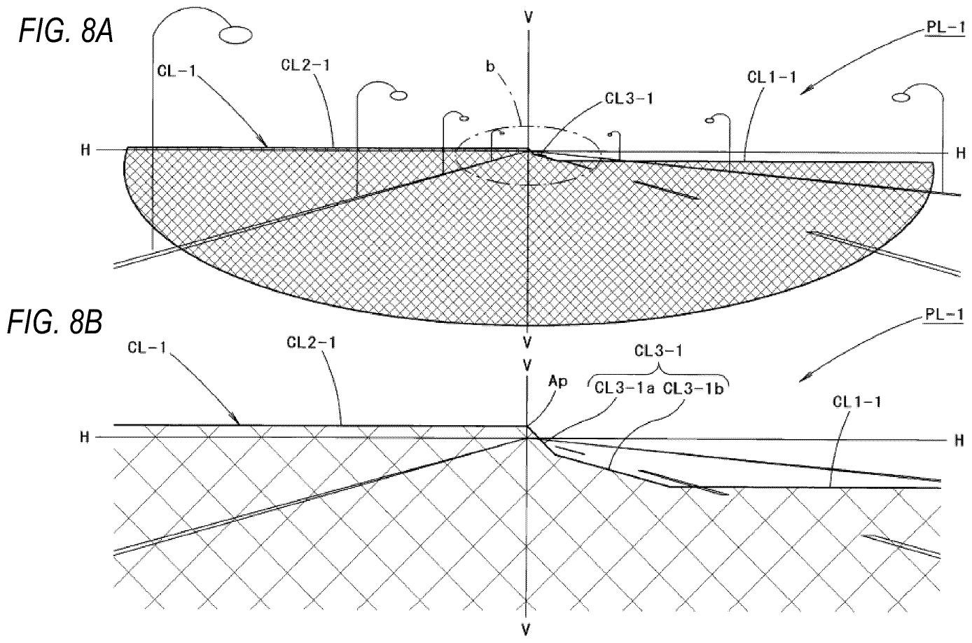

FIG. 8A is a diagram similar to FIG. 6A, showing a low beam light distribution pattern PL-1 formed by irradiation light from the vehicle lamp according to the present modification, and FIG. 8B is a diagram similar to FIG. 6B, showing a main part of the low beam light distribution pattern PL-1.

As shown in FIG. 8A, the basic shape of the low beam light distribution pattern PL-1 is the same as that of the above embodiment, and has a stepped cutoff line CL-1 in which a lower cutoff line CL1-1 and an upper cutoff line CL2-1 are connected via an inclined portion CL3-1.

As shown in FIG. 8B, in the low beam light distribution pattern PL-1, the inclination angle of the inclined portion CL3-1 of the stepped cutoff line CL-1 is also smaller in a lower region CL3-1b than in an upper region CL3-1a. Further, the connection position Ap between the inclined portion CL3-1 and the upper cutoff line CL2-1 in the stepped cutoff line CL-1 is set at the same position as in the case of the above embodiment.

However, the inclination angle of the inclined portion CL3-1 in the stepped cutoff line CL-1 is set to a value of about 45° in the upper region CL3-1a, and is set to a value of about 15° in the lower region CL3-1b. This is because the inclination angle of the slope region 128aS of the shade 128 is set to a value of approximately 45° in the lower half 128aS1 and is set to a value of approximately 15 ° in the upper half 128aS2.

Even when the configuration of the present modification is adopted, the low beam light distribution pattern PL-1 is set such that the inclination angle of the inclined portion CL3-1 of the stepped cutoff line CL2-1 is smaller in the lower region CL3-1b than in the upper region CL3-1a, so that it is possible to prevent glare to an oncoming vehicle driver or the like and to improve the long-distance visibility of the vehicle front travel path.

Next, a second modification of the above embodiment will be described.

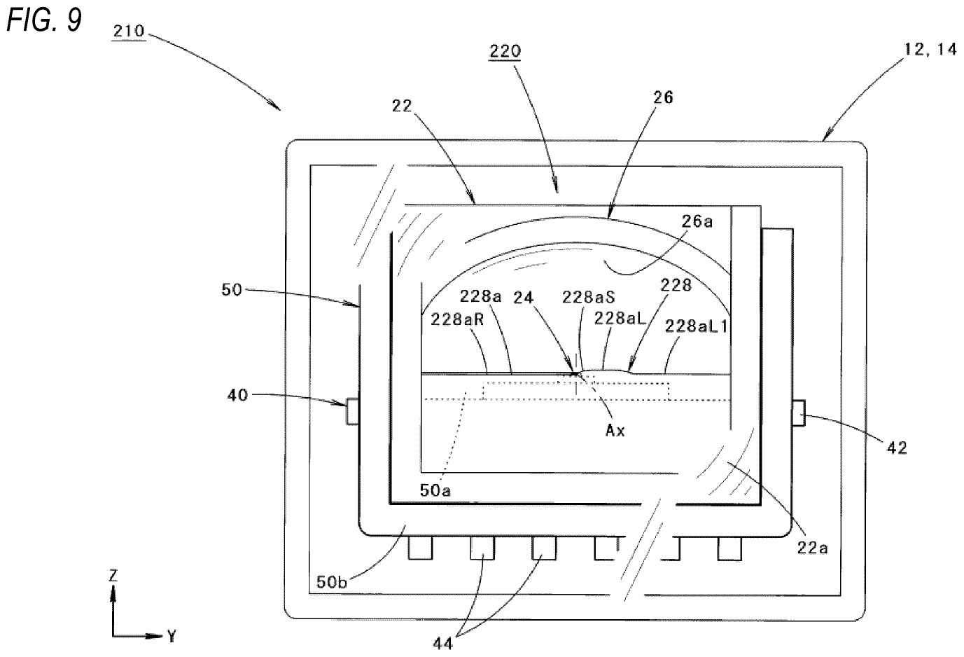

FIG. 9 is a view similar to FIG. 1, showing a vehicle lamp 210 according to the present modification.

As illustrated in FIG. 9, although a basic configuration according to the present modification is the same as that of the above embodiment, a configuration of a shade 228 of a lamp unit 220 is partially different from that of the above embodiment.

That is, in the shade 228 according to the present modification, the upward reflection surface 228a is also formed such that a right side region 228aR extends along the horizontal plane slightly below the optical axis Ax, and a left side region 228aL extends along the horizontal plane above the optical axis Ax via a slope region 228aS, but is different from the case of the above embodiment in that a part of the left side region 228aL is displaced downward.

Specifically, in the left side region 228aL, an outer region 228aL1 extending from a position separated from the slope region 228aS to the left by a certain distance to a left end edge portion is displaced downward with respect to a general region. The outer region 228aL1 is formed to extend in the horizontal direction slightly above a horizontal plane including the optical axis Ax.

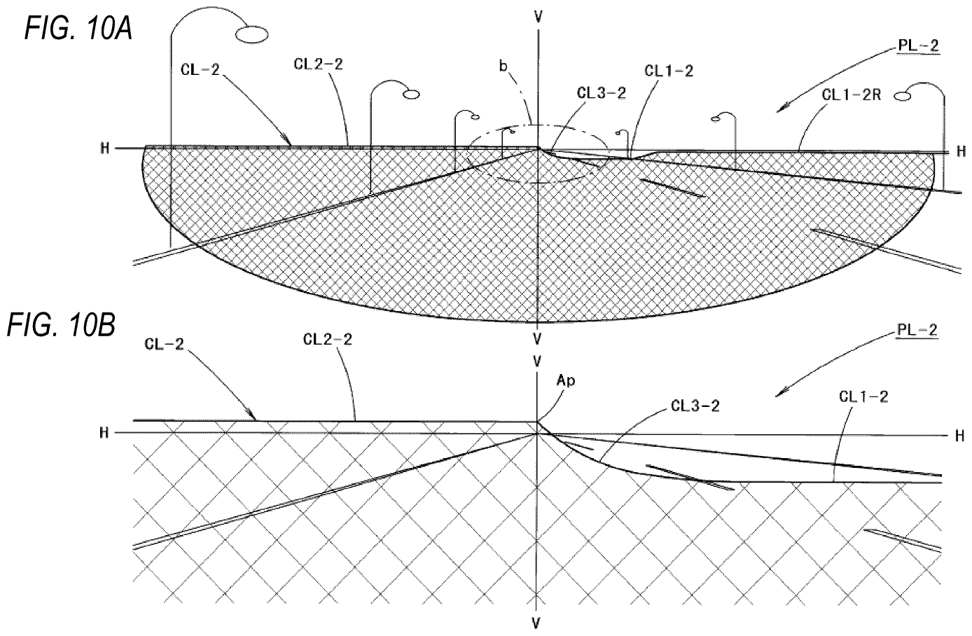

FIG. 10A is a diagram similar to FIG. 6A, showing a low beam light distribution pattern PL-2 formed by irradiation light from a vehicle lamp 210 according to the present modification, and FIG. 10B is a diagram similar to FIG. 6B, showing a main part of the low beam light distribution pattern PL-2.

As shown in FIG. 10A, the basic shape of the low beam light distribution pattern PL-2 is the same as that of the above embodiment, and has a stepped cutoff line CL-2 in which a lower cutoff line CL1-2 and an upper cutoff line CL2-2 are connected via an inclined portion CL3-2.

As shown in FIG. 10B, in the low beam light distribution pattern PL-2, the shape of the inclined portion CL3-2 of the stepped cutoff line CL-2 is also the same as in the case of the above embodiment, and the connection position Ap between the inclined portion CL3-2 and the upper cutoff line CL2-2 is set to the same position as in the case of the above embodiment.

However, the lower cutoff line CL1-2 of the stepped cutoff line CL-2 is higher by one step at a position separated from the inclined portion CL3-2 to the right by a certain distance.

Specifically, the lower cutoff line CL1-2 is formed such that a right end region CL1-2R from a position approximately 4° on the right side from the line V-V to a right end edge extends in the horizontal direction in the vicinity below the line H-H (specifically, at a position approximately 0.1° to 0.3° below the line H-H). This is because the outer region 228aL1 of the left side region 228aL in the upward reflection surface 228a of the shade 228 is displaced downward with respect to the general region.

Even when the configuration of the present modification is adopted, the low beam light distribution pattern PL-2 is set such that the inclination angle of the inclined portion CL3-2 of the stepped cutoff line CL-2 is smaller in the lower region than in the upper region, so that it is possible to prevent glare to an oncoming vehicle driver or the like and to improve the long-distance visibility of the vehicle front travel path.

In addition, in the present modification, the outer region 228aL 1 of the left side region 228aL in the upward reflection surface 228a of the shade 228 is displaced downward, and thus the right end region CL1-2R of the lower cutoff line CL1-2 in the low beam light distribution pattern PL-2 is one step higher, so that it is possible to prevent glare to an oncoming vehicle driver or the like and improve visibility of a road shoulder or the like on the oncoming traffic lane side.

It should be noted that numerical values shown as specifications in the above embodiment and the modifications thereof are merely examples, and as a matter of course, these numerical values may be set to different values as appropriate.

Further, the present invention is not limited to the configurations described in the above embodiment and the modifications thereof, and a configuration added with various other changes may be adopted.

The present international application claims priority based on Japanese Patent Application No. 2023-045241, which is a Japanese patent application filed on Mar. 22, 2023, and all contents of Japanese Patent Application No. 2023-045241 are incorporated in the present international application.

The above description of a specific embodiment of the present invention is presented for the purpose of illustration. The above description is not intended to be exhaustive or to limit the present invention to the described aspects as they are. It is apparent to those skilled in the art that many modifications and changes can be made in light of the above description.

### REFERENCE SIGNS LIST

10, 210: vehicle lamp
12: lamp body
14: translucent cover
20, 120, 220: lamp unit
22: projection lens
22a: front surface
22b: rear surface
24: light source
24a: light emitting surface
26: reflector
26a: reflection surface
28, 128, 228: shade
28a, 128a, 228a: upward reflection surface
28a1: front end edge
28a2: rear end edge
28aL, 128aL, 228aL: left side region
28aR, 128aR, 228aR: right side region
28aS, 128aS, 228aS: slope region
30: substrate
40: heat sink
42: main body portion
44: heat radiation fin
50: holder member
50a: horizontal flange portion
50b: frame portion
128aS1: lower half
128aS2: upper half
228aL1: outer region
A: connection position between slope region and right side region
Ap: connection position between inclined portion and upper cutoff line
Ax: optical axis
CL, CL-1, CL-2: stepped cutoff line
CL1, CL1-1, CL1-2: lower cutoff line
CL1-2R: right end region
CL2, CL2-1, CL2-2: upper cutoff line
CL3, CL3-1, CL3-2: inclined portion
CL3-1a: upper region
CL3-1b: lower region
E: elbow point
F: rear focal point
PL, PL-1, PL-2: low beam light distribution pattern

1. A vehicle lamp configured to form a low beam light distribution pattern, the vehicle lamp comprising:
a projection lens;
a light source disposed on a lamp rear side with respect to a rear focal point of the projection lens; and
a shade disposed between the light source and the projection lens, and configured to block a part of light emitted from the light source to form a cutoff line of the low beam light distribution pattern,
wherein the shade is configured to form, as the cutoff line, a stepped cutoff line in which a lower cutoff line and an upper cutoff line are connected via an inclined portion, and
wherein a shape of the shade is set such that an inclination angle of the inclined portion is smaller in a lower region than in an upper region of the inclined portion.

2. The vehicle lamp according to claim 1, wherein the shape of the shade is set such that the inclination angle of the inclined portion gradually decreases from an upper end edge toward a lower end edge of the inclined portion.

3. The vehicle lamp according to claim 2, wherein the shape of the shade is set such that the lower end edge of the inclined portion is smoothly connected to the lower cutoff line.

4. The vehicle lamp according to claim 1, further comprising:
a reflector disposed to cover the light source from above and configured to reflect the light emitted from the light source toward the projection lens,
wherein the shade is configured to block a part of light emitted from the light source and reflected by the reflector.

5. The vehicle lamp according to claim 4, wherein the shade has an upward reflection surface that reflects reflected light from the reflector upward toward the projection lens, and is configured to form the stepped cutoff line at a front end edge of the upward reflection surface.
